(19) United States
(12) Patent Application Publication
(10) Pub. No.: US 2026/0049551 A1
(43) Pub. Date: Feb. 19, 2026

(54) COMPUTER-IMPLEMENTED GEOCHEMICAL ANALYSIS OF RESERVOIR COMPARTMENTALIZATION USING COMPONENT CONCENTRATION SELECTION

(71) Applicant: SAUDI ARABIAN OIL COMPANY, Dhahran (SA)

(72) Inventors: Constantin SANDU, Houston, TX (US); Andrew Clarence SILVER, Houston, TX (US); Mohammed Abu ALREESH, Dhahran (SA)

(73) Assignee: SAUDI ARABIAN OIL COMPANY, Dhahran (SA)

(21) Appl. No.: 18/807,279

(22) Filed: Aug. 16, 2024

(51) Int. Cl. E21B 49/08; G06F 17/11

(52) U.S. Cl. CPC E21B 49/088; G06F 17/11

(57) ABSTRACT

Computer-implemented methods and systems for determining a distribution of a set of samples among multiple compartments of a reservoir are provided. A computer-implemented method includes storing a concentration composition of multiple components in a set of samples collected from different locations of the compartmentalized reservoir. The method includes computing a symmetric correlation matrix (SCM) having a number of elements, where each element of the SCM represents a correlation coefficient of a respective pair of component concentrations across all samples in the collected set. Other steps include applying first and second clustering algorithms, and assigning each sample from the set of samples to a respective compartment of the reservoir to obtain a compartment distribution of the set of samples across multiple compartments of the reservoir.

### CROSS-REFERENCE TO RELATED APPLICATIONS

None.

### BACKGROUND

Reservoir compartmentalization is used in the field of petroleum geology and reservoir engineering to analyze complex behavior of hydrocarbon reservoirs. Reservoir compartmentalization divides a hydrocarbon reservoir into distinct, completely- or partially-isolated compartments or zones, characterized by unique geological, physical, or fluid chemical properties. These compartments are separated by various geological barriers, such as faults, sealed fractures, or stratigraphic variations, which impede fluid flow and create distinct reservoir units.

These barriers can provide a number of challenges to the development of subsurface resources. For example, they can create weak zones that are difficult to drill through or may juxtapose zones with different pressures. Compartments may have fluid which reactivates under changing stress conditions and shear wellbores. Compartments may also cut out reservoir intervals along a planned well path. All these situations may require costly and inefficient sidetracks or cause the wellbore to be abandoned entirely.

One of the major uncertainties in planning a hydrocarbon field development is the efficiency of reservoir compartmentalization. For example, faults in the subsurface are known to exhibit a range of transmissibility behaviors to fluid flow ranging from completely open to completely sealed. Sealing faults will limit the drainage area for each individual wellbore and will control the communication between injector and producer wells. Correctly modeling this behavior is necessary for optimizing the development of a hydrocarbon field. Incorrect assessment of the transmissibility behavior of faults can lead to accelerated water breakthrough, poor pressure support, inefficient reservoir sweep, or overinvestment in well stock, any of which will negatively impact project economics.

Therefore, understanding reservoir compartmentalization is vital for effectively managing and optimizing hydrocarbon recovery strategies. It enables reservoir engineers and geoscientists to delineate and characterize different reservoir compartments, thereby facilitating accurate reservoir modeling, simulation, and predictive analysis. By comprehensively evaluating the connectivity and communication pathways between compartments, experts can identify potential production challenges, such as fluid migration, pressure differentials, and compartmental heterogeneity, and devise tailored reservoir management plans to mitigate these issues. Moreover, reservoir compartmentalization significantly impacts the estimation of hydrocarbon reserves and the overall economic viability of exploration and production projects. Adequate assessment of compartmentalization assists in minimizing uncertainties related to reservoir performance, enhancing production forecasting accuracy, and optimizing recovery efficiency, thereby maximizing the commercial success of oil and gas operations.

For hydrocarbon reservoirs, petroleum geochemistry provides a tool for understanding reservoir characteristics with respect to oil flow and tracing out elements of basin scale migration patterns and reservoir compartmentalization. Chemometric analysis uses a systematic approach that integrates statistical techniques with geochemical interpretation. Geochemical data and biomarker components are analyzed to determine different compartments within a hydrocarbon reservoir. Geoscientists and reservoir engineers rely on the power of chemometrics to uncover valuable insights into geochemistry data to map the reservoir compartments based on the spatial distribution of geochemical data and biomarker components.

However, what is needed are improved methods and systems for determining sample allocation across different compartments of a hydrocarbon reservoir.

### BRIEF SUMMARY

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

Computer-implemented methods, systems, and non-transitory computer-readable storage medium for determining a distribution of a set of samples among multiple compartments of a reservoir are provided.

In one aspect, a computer-implemented method includes storing, in computer-readable memory, a concentration composition of multiple components in a set of samples collected from different locations of the compartmentalized reservoir. The method includes computing, with at least one processor, a symmetric correlation matrix (SCM) having a number of elements. Each element of the SCM represents a correlation coefficient of a respective pair of component concentrations across all samples in the collected set. Other steps include applying, with at least one processor, a first clustering algorithm on the elements of the SCM to obtain a set of distinct clusters and selecting a subset of elements within each cluster which satisfy a proximity criterion for a center of their respective cluster, and applying, with at least one processor, a second clustering algorithm to the set of samples based on a selected group of component concentrations to obtain a grouping of the samples where the number of clusters is selected based on a point of linear discontinuity in a Euclidean distance trend function. Finally, the method includes assigning, with at least one processor, each sample from the set of samples to a respective compartment of the reservoir to obtain a compartment distribution of the set of samples across multiple compartments of the reservoir.

In another aspect, a computing apparatus includes computer-readable memory configured to store a concentration composition of multiple components in a set of samples collected from different locations of the compartmentalized reservoir and at least one processor configured to perform operations to compute a SCM, apply first and second clustering algorithms, and assign each sample from the set of samples to a respective compartment of a reservoir to obtain a compartment distribution of the set of samples across multiple compartments of the reservoir.

In a still further aspect, a system for determining a distribution of a set of samples among multiple compartments of a reservoir includes a data repository configured to store data representative of a set of samples collected from different locations of a compartmentalized reservoir. The system also includes an analysis tool including a geochemical data analyzer and a reservoir mapper, and a user-interface configured to enable a user to interact with the analysis tool and the data repository.

The geochemical data analyzer is configured to: compute a SCM, apply a first clustering algorithm on the elements of the SCM to obtain a set of distinct clusters and selecting a subset of elements within each cluster which satisfy a proximity criterion for a center of their respective cluster, and apply a second clustering algorithm to the set of samples based on a selected group of component concentrations to obtain a grouping of the samples where the number of clusters is selected based on a point of linear discontinuity in a Euclidean distance trend function. The reservoir mapper is configured to assign each sample from the set of samples to a respective compartment of the reservoir to obtain a compartment distribution of the set of samples across multiple compartments of the reservoir.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 is a diagram that illustrates compartments in a hydrocarbon reservoir in accordance with an embodiment.

FIG. 2 illustrates a routine 200 for determining a distribution of a set of samples among multiple compartments of a reservoir in accordance with one embodiment.

FIG. 3A is a diagram that illustrates a set of samples collected from different well locations across a reservoir in an embodiment.

FIG. 3B illustrates a table having components concentration data extracted from samples of oil in the reservoir of FIG. 3A according to one example.

FIG. 4 is a diagram that illustrates aspects of a correlation matrix in accordance with one embodiment.

FIG. 5 is a diagram that illustrates aspects of a correlation matrix after a clustering algorithm is applied in accordance with an embodiment.

FIG. 6 is a diagram that illustrates a subset of elements representing selected components and correlations in accordance with an embodiment.

FIG. 7 is a diagram that illustrates different levels of groupings of the collected set of samples based on a clustering algorithm in accordance with an embodiment.

FIG. 8 is a plot diagram that illustrates a Euclidean distance trend function according to an embodiment.

FIG. 9 is a diagram that illustrates a compartment distribution based on the results of a clustering algorithm in accordance with an embodiment.

FIG. 10 is a block diagram of an exploration and production system according to an embodiment.

FIG. 11 is a block diagram of a computer system in accordance with one embodiment.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

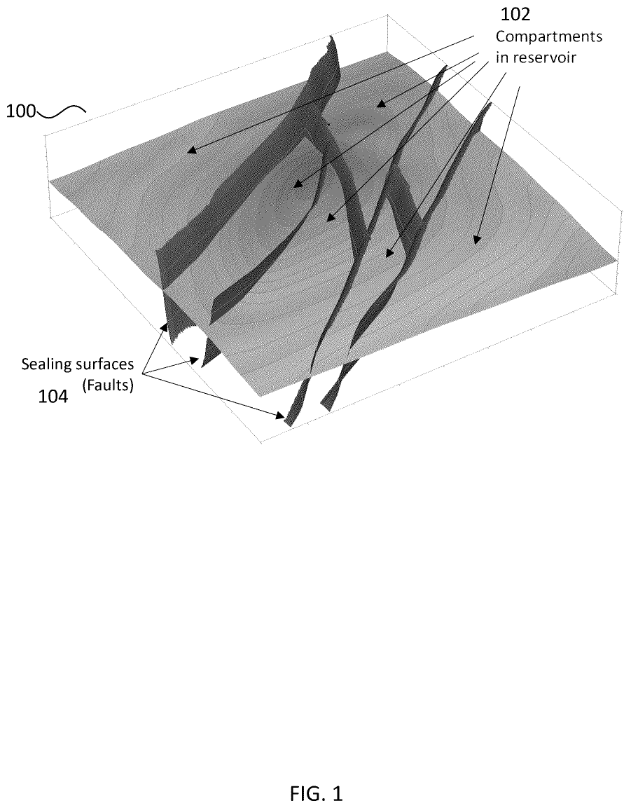

FIG. 1 is a diagram that illustrates an example hydrocarbon reservoir 100 in accordance with an embodiment. Hydrocarbon reservoir 100 is made up of different compartments 102 separated by faults 104. Compartments 102 may be distinct, completely- or partially-isolated zones, characterized by unique geological, physical, and/or fluid chemical properties. Faults 104 may be various geological barriers, such as geologic faults, sealed fractures, or stratigraphic variations, which impede fluid flow and create distinct reservoir zones.

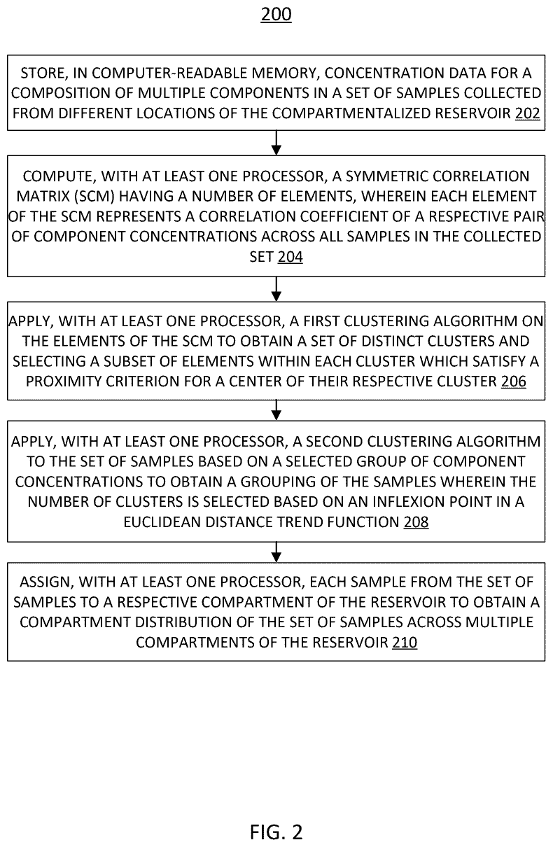

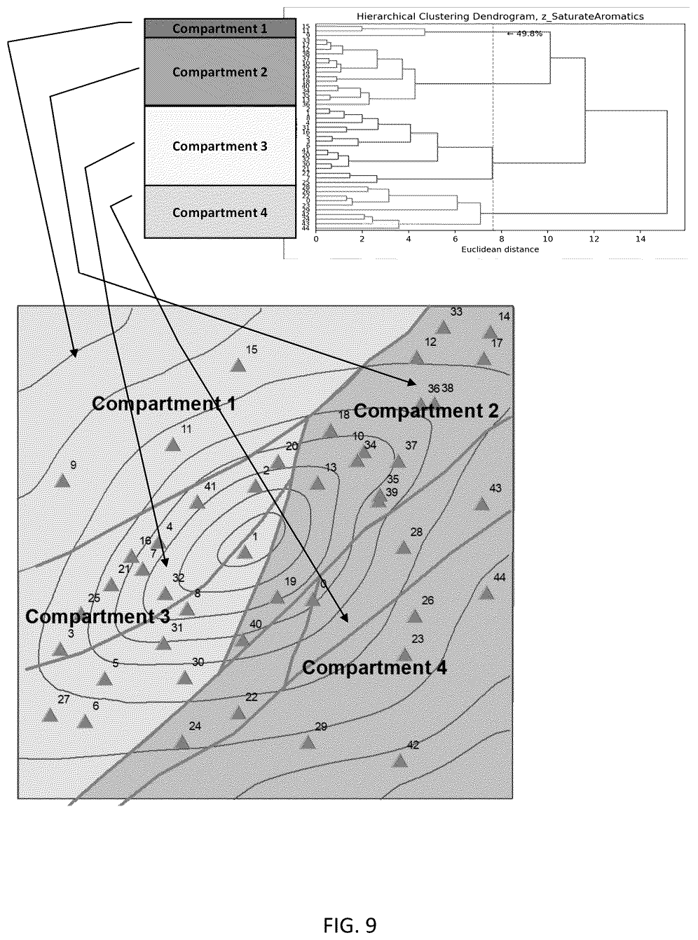

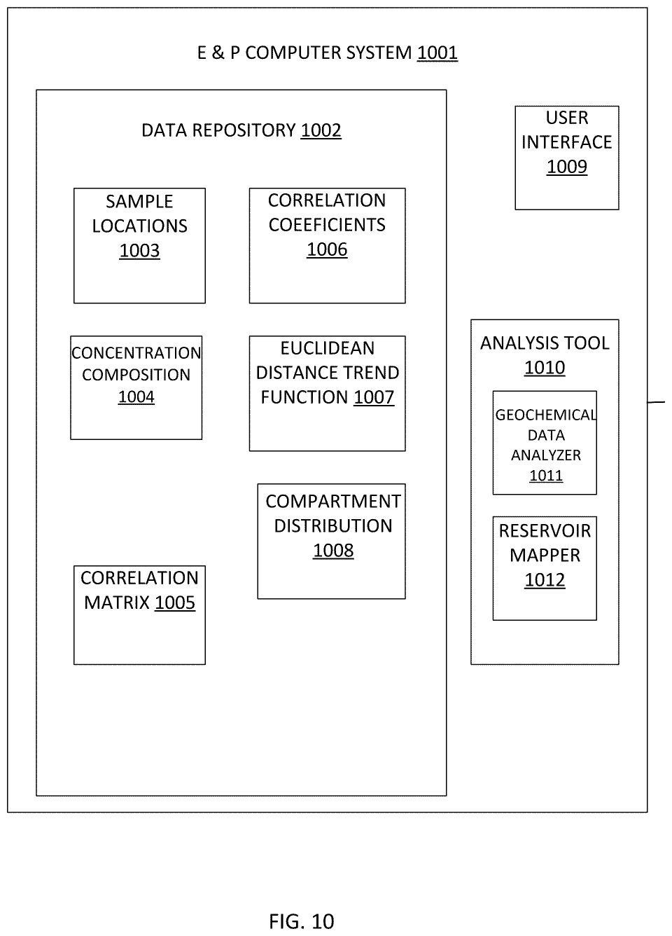

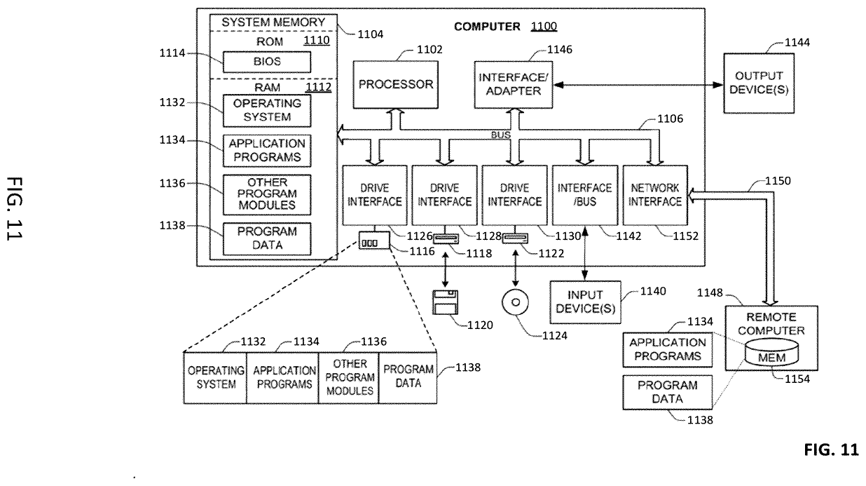

FIG. 2 illustrates a method 200 for determining a distribution of a set of samples among multiple compartments of a reservoir in accordance with one embodiment (steps 202-210). In embodiments, method 200 may be implemented on a computing device having at least one processor and computer-readable memory. In one embodiment, method 200 may be implemented on an exploration and production (E&P) computer system as described further below with respect to FIG. 10. In a further embodiment, method 200 may be implemented on a computer processing system as described further below with respect to FIG. 11.

Method 200 includes storing, in computer-readable memory, concentration data for a composition of multiple components in a set of samples collected from different locations of a compartmentalized reservoir (step 202).

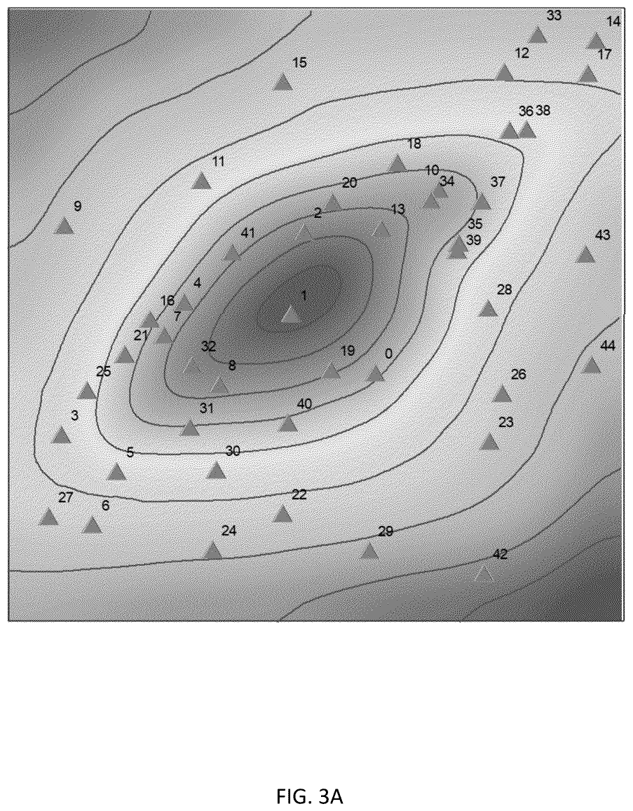

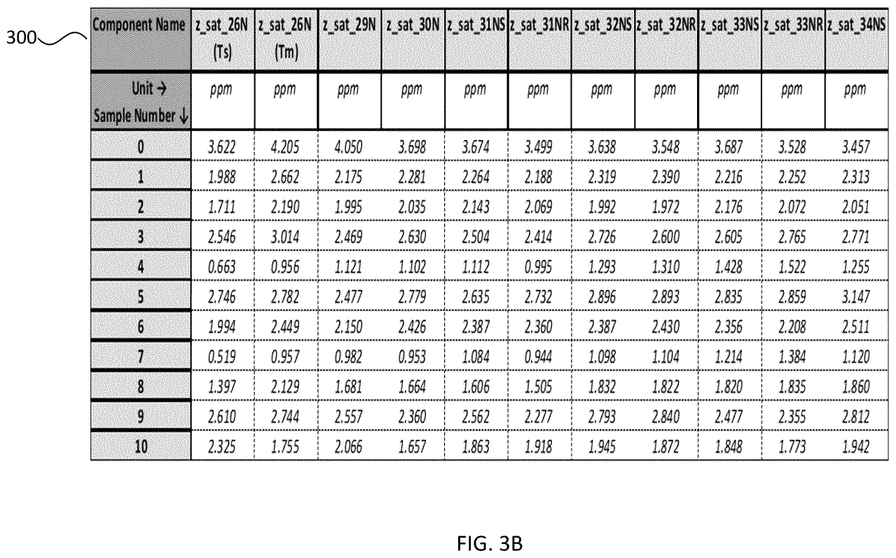

As shown in the example of FIG. 3A, a set of samples (denoted by triangles 1-44) may be collected from different well locations across a reservoir. At least some of the collected samples may be from different compartments of the reservoir. In some applications involving a hydrocarbon reservoir, samples may be analyzed through Gas Chromatography-Mass Spectrometry (GCMS) or other laboratory methods to identify and quantify a large set of biomarkers or other trace amount of components present in sampled oil. Such concentration data (also called concentration composition data) obtained for multiple components in the set of samples is stored in computer-readable memory.

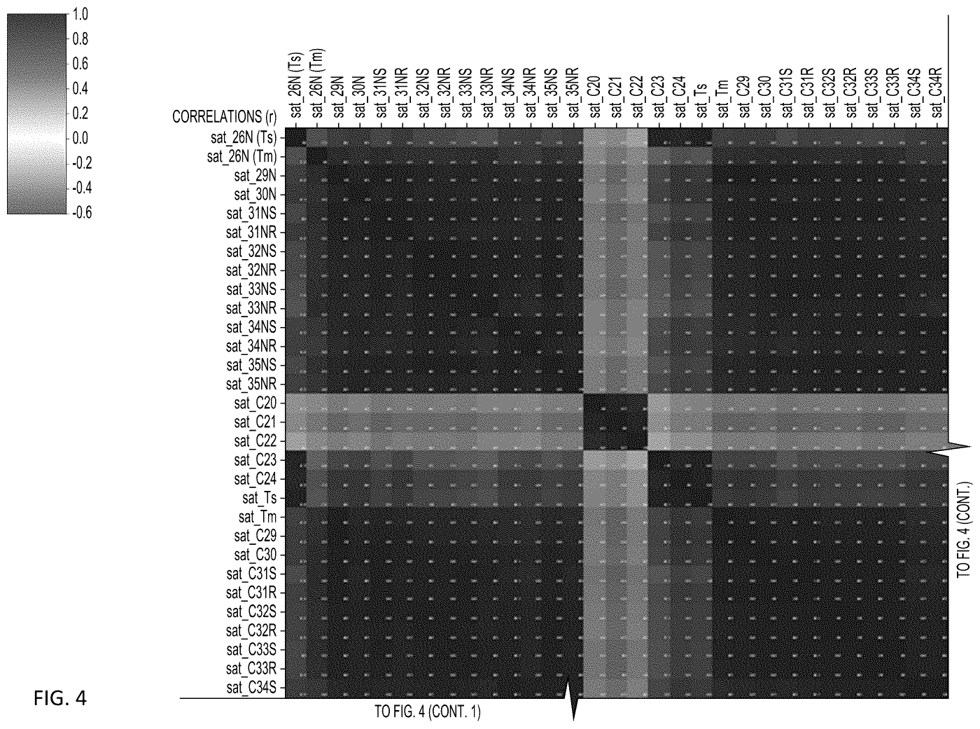

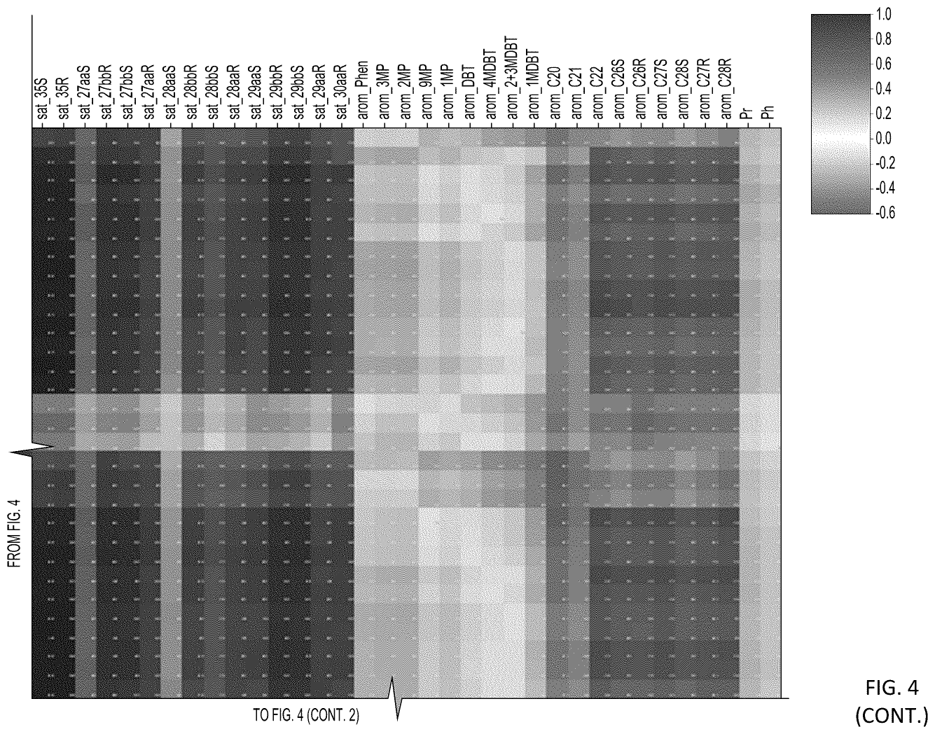

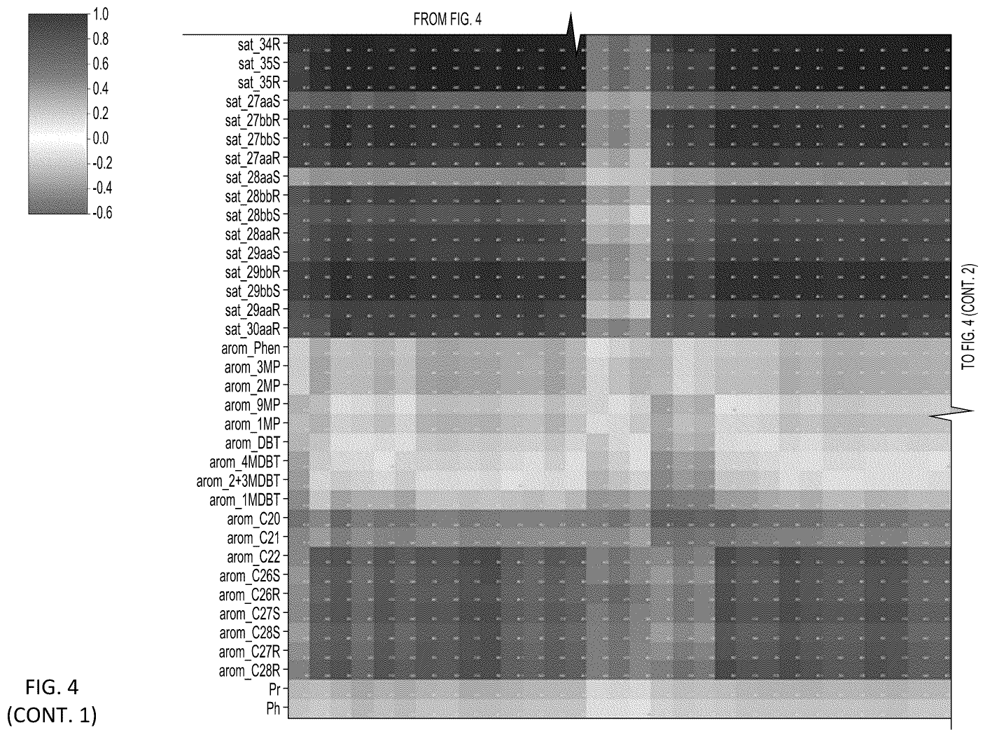

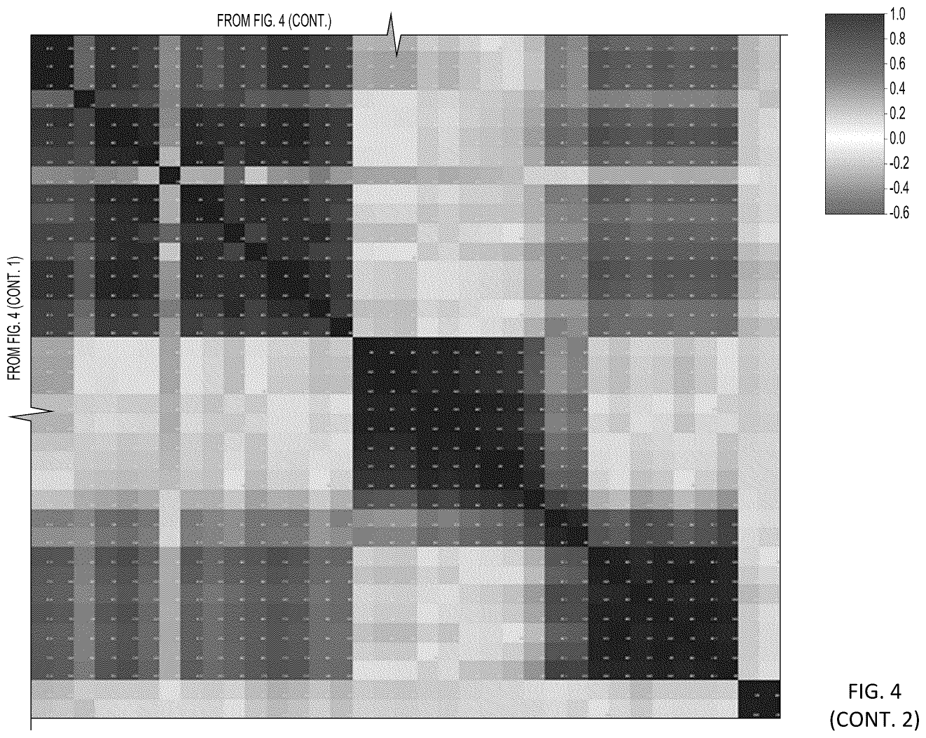

FIG. 3B illustrates a table 300 having concentration data for components extracted from samples of oil in the reservoir of FIG. 3A according to one example. Table 300 contains a subset of components measured and their concentration in parts per million (ppm) in oil samples collected across a hydrocarbon reservoir 100. The table shows concentration data for eleven components in respective columns (Component Name) for eleven samples in respective rows (Sample Numbers 0-10). The eleven components are denoted by z_sat_26N to z_sat_34N (which are derived from some specific chemical compounds names). The letters serve for component identification and show part of a component name. For example, N stands for Norhopane (a series of C26-C34 compounds) and S, R represents specific positions of isomers. Ts and Tm in parentheses are the nicknames of some Norhopanes (Trisnorneohopane and Trisnorhopane). The table only shows a partial list of components used (for illustration purpose). A further list is shown in FIG. 4 as labels of the correlation matrix elements.

In step 204, control proceeds to compute, with at least one processor, a symmetric correlation matrix (SCM) having a number of elements. Each element of the SCM represents a correlation coefficient of a respective pair of component concentrations across all samples in the collected set. A correlation coefficient is a statistical measure of the strength and direction of a linear relationship between two variables (i.e. how close the data points representing multiple samples plot along a line on a graph with the two variables as coordinates). There are multiple methods to calculate a correlation coefficient. For example, a Pearson correlation coefficient may be used as a correlation coefficient that measures linear correlation between two sets of data. The correlation is thus calculated between each pair of components and their respective concentration across all samples. In other words, concentration data for the set of collected samples may be used as statistical variables considered in a multi-variate analysis.

FIG. 4 depicts a graphical representation of an example correlation matrix among all the components considered and analyzed when compared across all collected samples. Each colored square in the correlation matrix represents the value of the correlation coefficient between two components for a respective row and column that give the respective element its coordinates in the matrix. In FIG. 4, the intensity of color is proportional with the level of correlation. Red color denotes positive correlation while blue represents inverse correlation in a range between −0.6 and 1.0. The stronger the correlation, the closer the correlation coefficient comes to an absolute value of one (±1).

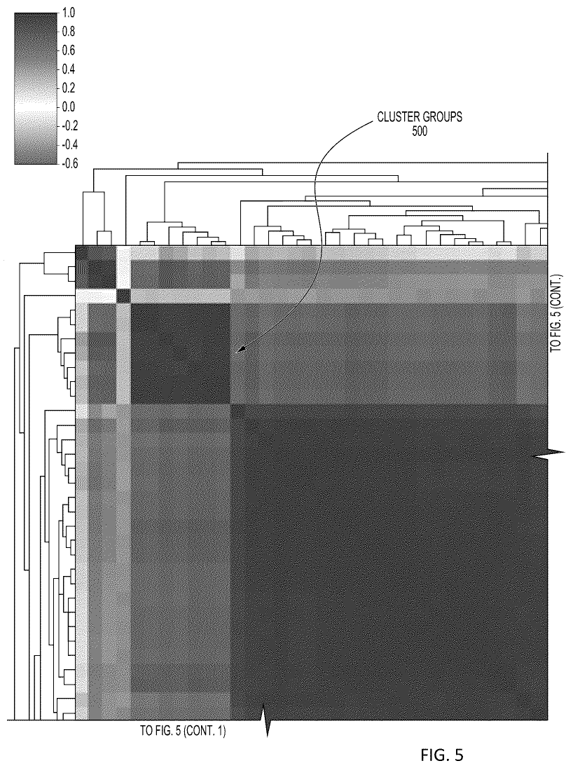

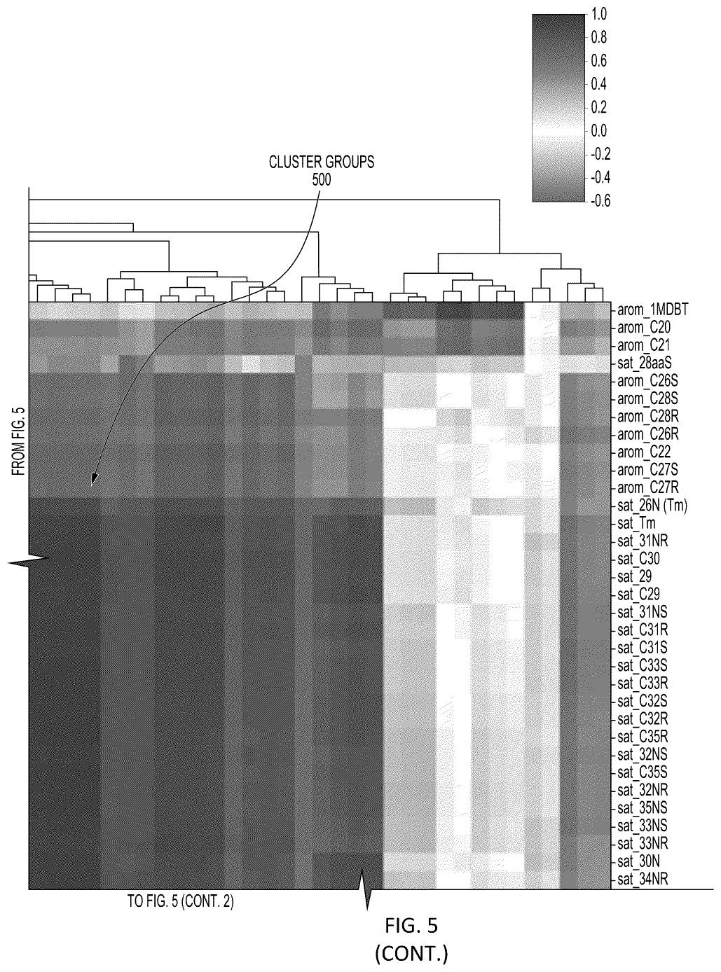

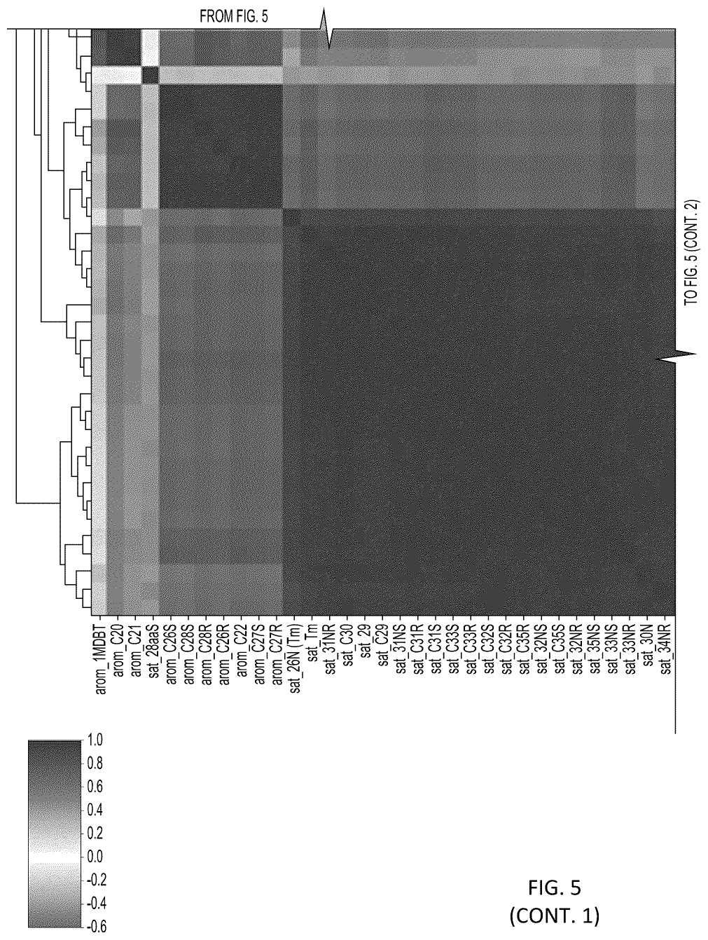

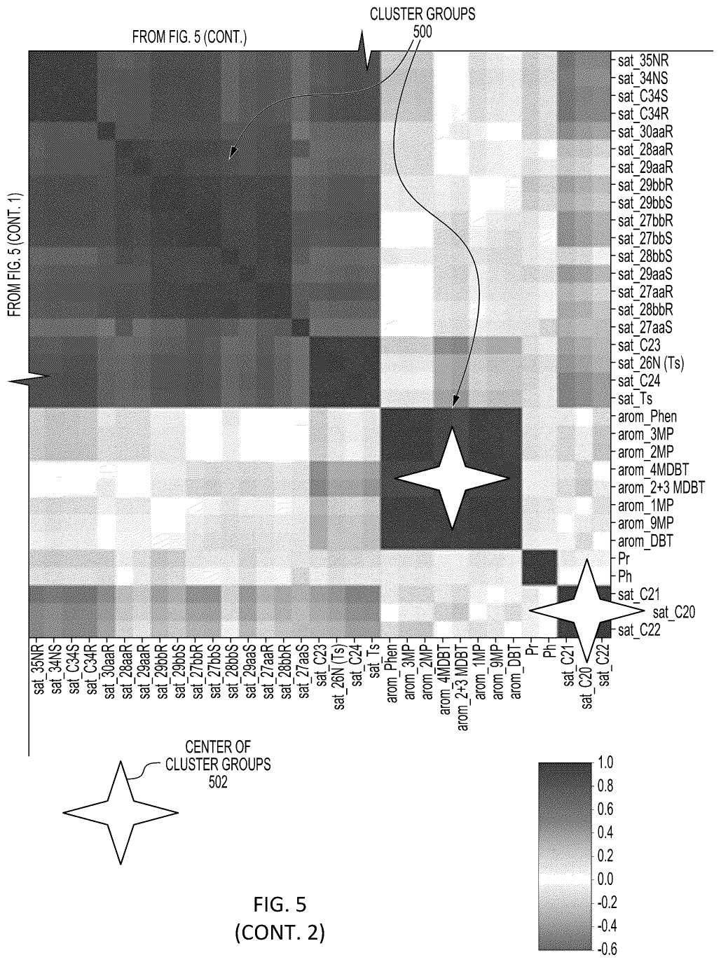

Next, control proceeds to step 206. In step 206, the method includes applying, with at least one processor, a first clustering algorithm on the elements of the SCM to obtain a set of distinct clusters and selecting a subset of elements within each cluster which satisfy a proximity criterion for a center of their respective cluster. For example, the first clustering algorithm, may perform a clustering analysis on the elements of the correlation matrix. The clustering analysis groups the components with similar variability together. The first clustering algorithm may perform a hierarchical clustering analysis (HCA) having an algorithm that groups similar objects into groups called clusters. FIG. 5 is a diagram that illustrates aspects of a correlation matrix after a first clustering algorithm is applied in accordance with an embodiment. Using the first clustering algorithm, the elements were grouped in cluster groups 500 based on a similarity criterion. A subset of elements was selected at each center 502 of the cluster groups 500.

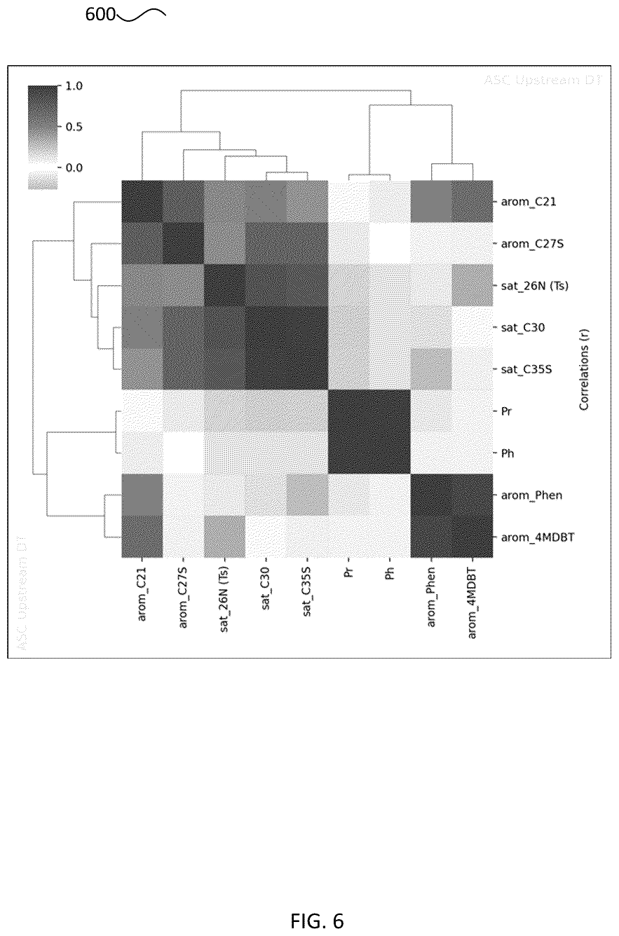

In one embodiment, the grouping carried out by the first clustering algorithm is based on the distance of each variable (sample) from the center of the cluster in a multidimensional Euclidian space with each dimension represented by a variable. The endpoint is a set of cluster groups 500, where each cluster group (or cluster) is distinct from one another, and the objects within each cluster are broadly similar to one another. The main target of this cluster analysis is to find groups within a given data set based on the principle for which similar objects are represented by close points in the space of the variables which describe them. One way to define the similarity level of samples is that its value increases the more the objects are similar. Once clustering is obtained, a subset of elements is selected, where each element satisfies a proximity criterion for a center 502 of their respective cluster group 500. The selection of components may be based just on the position of the center of cluster in component coordinates or may involve other geological considerations. In other words, the first clustering algorithm can select a set of components that represent each group of similar varying components, thus eliminating the redundant components with similar variability (situated within the same cluster group). The resulted selection is presented in FIG. 6 in a form of a reclustered heat plot 600 for quality control and convenient visualization. Heat plot 600 shows a plot of the correlation values for the reclustered selected samples (e.g., arom_C21, arom_C27S, sat_26N (Ts), sat_C30, sat_C35S, Pr, Ph, arom_Phen, and arom_4MDBT) which is simpler and more clear because the redundant components with similar variability in a cluster group have been removed.

Next, control proceeds to step 208. In step 208, the method includes applying, with at least one processor, a second clustering algorithm to the set of samples based on a selected group of component concentrations to obtain a grouping of the samples where the number of clusters is selected based on a point of linear discontinuity in a Euclidean distance trend function. Cluster analysis is performed in step 208 on the set of samples based on the selected significant compounds (rather than on components based on samples like in the previous step 206). For example, the cluster analysis in step 208 can be used in geological interpretation of geochemistry data to observe subsurface conditions that may lead to samples being more or less similar among them. More dissimilar samples may prove more isolated compartments of a reservoir.

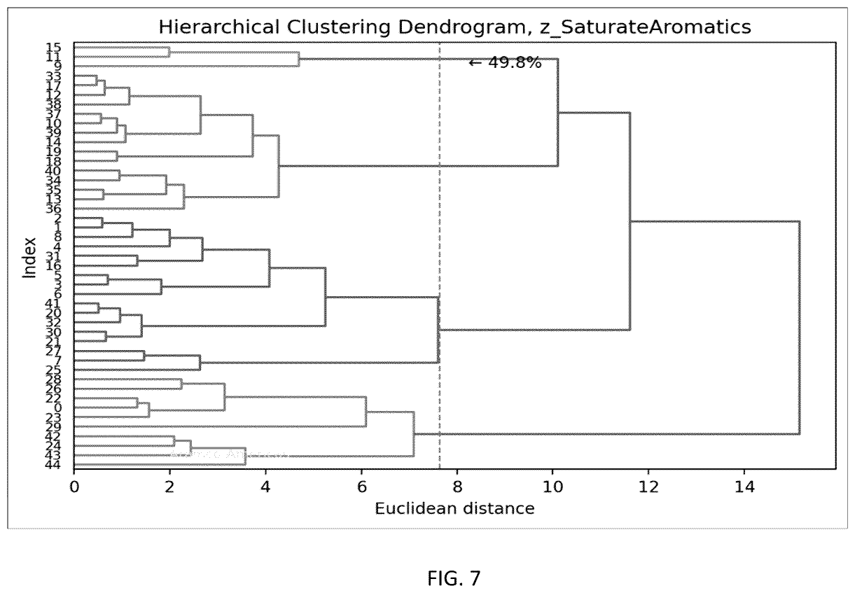

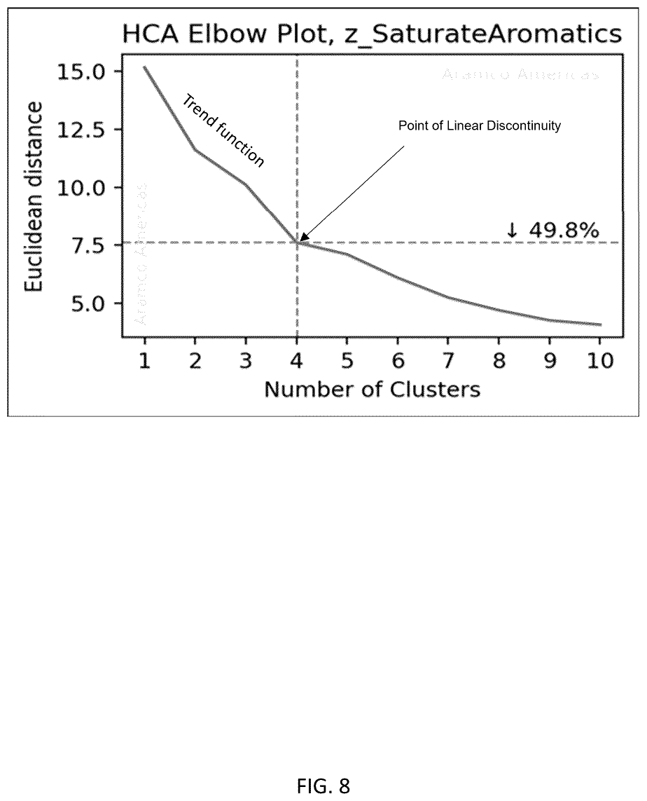

FIG. 7 is a dendrogram that shows the hierarchical clusters for the samples with different levels of grouping based on the similarity among the samples calculated for the selected significant compounds in step 208. The y axis labeled Index shows samples while the x axis shows the Euclidean distance for the samples. The number of clusters is selected based on the point of linear discontinuity in a Euclidean distance trend function as shown in the diagram of FIG. 8. For example, the point of discontinuity may be a point where a discontinuous change in a gradient of the Euclidean distance trend function occurs. In FIG. 8, the point occurs at or about the Euclidean distance just above 7.5 at the number of clusters equal to 4. In this way, the number of clusters selected in this example is four and control proceeds to assigning step 210.

In step 210, the method involves assigning, with at least one processor, each sample from the set of samples to a respective compartment of the reservoir to obtain a compartment distribution of the set of samples across multiple compartments of the reservoir. In the example of FIG. 3A mentioned above, each sample from the set of samples (1-44) is assigned to a compartment of the compartmentalized reservoir to obtain the compartment distribution shown in FIG. 9. The compartment distribution is based on the results of the clustering operation developed in prior step 208. As shown in the graphical representation in FIG. 9, the compartments are delineated by mapping the samples distributed according to their cluster identity. Additional geologic criteria, like the presence of faults being identified for example, may help delincating the compartments. Essentially, the compartment distribution results from mapping and interpolating the sample location based on the four groups (that is, number of clusters equals 4 in the inflection point in the example of FIG. 8) established in the clustering analysis of step 208. In the example shown in FIG. 9 then compartment 1 corresponds to a region of the reservoir having samples 9, 11, 15; compartment 2 corresponds to a different region of the reservoir having samples 10, 12, 13, 14, 17, 18, 19, 33, 34, 35, 36, 37, 38, 39, 40; compartment 3 corresponds to a different region of the reservoir having samples 1, 2, 3, 4, 5, 6, 7, 8, 16, 20, 21, 26, 27, 30, 31, 32, 41; and compartment 4 corresponds to a different region of the reservoir having samples 0, 22, 23, 24, 26, 28, 29, 42, 43, 44.

Finally, one or more field operations may be executed based on the compartment distribution assigned in step 210. For example, the field operation may be extracting oil from one or more compartments 1-4.

FIG. 10 shows an exploration and production (E & P) computer system 1001 according to an embodiment. According to a feature, E & P system 1001 determines a distribution of a set of samples among multiple compartments of a reservoir. E & P system 1001 includes a data repository 1002, user interface 1009, and analysis tool 1010.

Data repository 1002 is configured to store data representative of a set of samples collected from different locations of a compartmentalized reservoir. User-interface 1009 is configured to enable a user to interact with analysis tool 1010 and data repository 1002. Analysis tool 1010 includes a geochemical data analyzer 1011 and a reservoir mapper 1012. In example implementations, analysis tool 1010 including its components (geochemical data analyzer 1011 and a reservoir mapper 1012) may be implemented in software, firmware, hardware or any combination thereof on the same. A network interface (not shown) may be used to allow the E & P computer system 1001 including analysis tool 1010 to communicate over a network or combination of networks.

In operation, geochemical data analyzer 1011 is configured to compute a symmetric correlation matrix (SCM) having a number of elements. As described above with respect to step 204, each element of the SCM represents a correlation coefficient of a respective pair of component concentrations across all samples in a set of samples collected from different locations of a compartmentalized reservoir.

Geochemical data analyzer 1011 then applies first and second clustering algorithms. In particular, geochemical data analyzer 1011 applies a first clustering algorithm on the elements of the SCM to obtain a set of distinct clusters and selects a subset of elements within each cluster which satisfy a proximity criterion for a center of their respective cluster. In this way, the first clustering algorithm may operate as described above with respect to step 206.

Next geochemical data analyzer 1011 applies a second clustering algorithm to the set of samples based on a selected group of component concentrations to obtain a grouping of the samples wherein the number of clusters is selected based on a point of linear discontinuity in a Euclidean distance trend function. In this way, the second clustering algorithm may operate as described above with respect to step 208.

Reservoir mapper 1012 is configured to assign each sample from the set of samples to a respective compartment of the reservoir to obtain a compartment distribution of the set of samples across multiple compartments of the reservoir. This assignment may be performed as described above with respect to step 210. In this way, reservoir mapper 1012 performs location-based data analysis and visualization (puts the samples on the map and relates them to the location of the reservoir compartments).

As shown in FIG. 10, data repository 1002 stores sample locations data 1003 and concentration composition data 1004 for the set of samples collected from different locations of the compartmentalized reservoir. Geochemical data analyzer 1011 outputs the computed SCM correlation matrix 1005 for storage in data repository 1002. Data repository 1002 further stores data on correlation coefficients 1006 and a Euclidean distance trend function 1007 for access by geochemical data analyzer 1011. Reservoir mapper 1012 further outputs the compartment distribution data 1008 for storage in data repository 1002.

Analysis tool 1010 generates a display view of the compartment distribution and user-interface 1009 enables a user to view and navigate through compartment distribution shown in the display view.

### Further Computer-Implemented Embodiments

As described above, routine 200 and E & P computer system 1001 may be implemented on any type of computing device including, but not limited to, a laptop, desktop, tablet, workstation, mobile device or smartphone, kiosk, embedded system, or other computing device having at least one processor and a non-transitory computable readable memory. The computing device may include a browser, application, and operating system along with a user-interface depending upon a desired configuration. The computing device may have functionality performed at the same or different physical locations and by one or more processors located at the same or different locations. A computing device may also be coupled to one or more application programming interfaces (APIs) to perform or distribute aspects of the functionality described herein. Computing functionality as described herein may also be implemented on a server, cluster of servers, web server, cloud-computing platform and/or other remote service. A client/server architecture may also be implemented as would be apparent to a person skilled in the art given this description.

### Example Computing Environment

FIG. 11 depicts an example computing environment having a computing device (e.g., computer 1100) that can be used in systems and methods according to embodiments.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11.

In this regard, FIG. 11 illustrates one example of a computer 1100 that can be employed to execute one or more embodiments of the present disclosure. Computer 1100 can be implemented on one or more general purpose networked computer systems, embedded computer systems, routers, switches, server devices, client devices, various intermediate devices/nodes or standalone computer systems. Additionally, computer 1100 can be implemented on various mobile clients such as, for example, a smartphone, personal digital assistant (PDA), laptop computer, pager, and the like, provided it includes sufficient processing capabilities.

Computer 1100 includes processing unit 1102, system memory 1104, and system bus 1106 that couples various system components, including the system memory 1104, to processing unit 1102. Dual microprocessors and other multi-processor architectures also can be used as processing unit 1102. System bus 1106 may be any of several types of bus structure including a memory bus or memory controller, a peripheral bus, and a local bus using any of a variety of bus architectures. System memory 1104 includes read only memory (ROM) 1110 and random access memory (RAM) 1112. A basic input/output system (BIOS) 1114 can reside in ROM 1112 containing the basic routines that help to transfer information among elements within computer system 1100.

Computer 1100 can include a hard disk drive 1116, magnetic disk drive 1118, e.g., to read from or write to removable disk 1120, and an optical disk drive 1122, e.g., for reading CD-ROM disk 1124 or to read from or write to other optical media. Hard disk drive 1116, magnetic disk drive 1118, and optical disk drive 1122 are connected to system bus 1106 by a hard disk drive interface 1126, a magnetic disk drive interface 1128, and an optical drive interface 1130, respectively. The drives and associated computer-readable media provide nonvolatile storage of data, data structures, and computer-executable instructions for computer 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and disclosed herein. A number of program modules may be stored in drives and RAM 1112, including operating system 1132, one or more application programs 1134, other program modules 1136, and program data 1138. In some examples, the application programs 1134 can include one or more modules (or block diagrams), or systems, as shown and disclosed herein. Thus, in some examples, application programs 1134 can include functionality to implement analysis tool 1010 including geochemical data analyzer 1011 and reservoir mapper 1012.

A user may enter commands and information into computer 1100 through one or more input devices 1140, such as a pointing device (e.g., a mouse, touch screen), keyboard, microphone, joystick, game pad, scanner, and the like. These and other input devices are often connected to processing unit 1102 through a corresponding port interface 1142 that is coupled to the system bus, but may be connected by other interfaces, such as a parallel port, serial port, or universal serial bus (USB). One or more output devices 1144 (e.g., display, a monitor, printer, projector, or other type of displaying device) is also connected to system bus 1106 via interface 1146, such as a video adapter.

Computer 1100 may operate in a networked environment using logical connections to one or more remote computers, such as remote computer 1148. Remote computer 1148 may be a workstation, computer system, router, peer device, or other common network node, and typically includes many or all the elements described relative to computer system 1100. The logical connections, schematically indicated at 1150, can include a local area network (LAN) and a wide area network (WAN). When used in a LAN networking environment, computer system 1100 can be connected to the local network through a network interface or adapter 1152. When used in a WAN networking environment, computer system 1100 can include a modem, or can be connected to a communications server on the LAN. The modem, which may be internal or external, can be connected to system bus 1106 via an appropriate port interface. In a networked environment, application programs 1134 or program data 1138 depicted relative to computer system 1100, or portions thereof, may be stored in a remote memory storage device 1154.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number. The present disclosure is also directed to the following exemplary embodiments, which can be practiced in any combination thereof:

Embodiment A: A computer-implemented method for determining a distribution of a set of samples among multiple compartments of a reservoir, comprising: storing, in computer-readable memory, a concentration composition of multiple components in a set of samples collected from different locations of the compartmentalized reservoir; computing, with at least one processor, a symmetric correlation matrix (SCM) having a number of elements, wherein each element of the SCM represents a correlation coefficient of a respective pair of component concentrations across all samples in the collected set; applying, with at least one processor, a first clustering algorithm on the elements of the SCM to obtain a set of distinct clusters and selecting a subset of elements within each cluster which satisfy a proximity criterion for a center of their respective cluster; applying, with at least one processor, a second clustering algorithm to the set of samples based on a selected group of component concentrations to obtain a grouping of the samples wherein the number of clusters is selected based on a point of linear discontinuity in a Euclidean distance trend function; and assigning, with at least one processor, each sample from the set of samples to a respective compartment of the reservoir to obtain a compartment distribution of the set of samples across multiple compartments of the reservoir.

Embodiment A may have one or more of the following additional elements A1-A4 in any combination or all in combination: Element A1 further comprising executing a field operation based on the assigned compartment distribution. Element A2 wherein the selecting the subset of elements which satisfies the proximity criterion for the center of their respective cluster includes maintaining minimal similarity to elements of other clusters. Element A3 wherein the selecting the subset of elements which satisfies the proximity criterion for the center of their respective cluster includes applying geologic criteria. Element A4 wherein the reservoir comprises a hydrocarbon reservoir.

Embodiment B: A computing apparatus for determining a distribution of a set of samples among multiple compartments of a reservoir comprising: computer-readable memory configured to store a concentration composition of multiple components in a set of samples collected from different locations of the compartmentalized reservoir; and at least one processor configured to perform the following operations: compute a symmetric correlation matrix (SCM) having a number of elements, wherein each element of the SCM represents a correlation coefficient of a respective pair of component concentrations across all samples in the collected set; apply a first clustering algorithm on the elements of the SCM to obtain a set of distinct clusters and selecting a subset of elements within each cluster which satisfy a proximity criterion for a center of their respective cluster; apply a second clustering algorithm to the set of samples based on a selected group of component concentrations to obtain a grouping of the samples wherein the number of clusters is selected based on a point of linear discontinuity in a Euclidean distance trend function; and assign each sample from the set of samples to a respective compartment of the reservoir to obtain a compartment distribution of the set of samples across multiple compartments of the reservoir.

Embodiment B may have one or more of the following additional elements B1-B3 in any combination or all in combination. Element B1 wherein the at least one processor is further configured to select the subset of elements which satisfies the proximity criterion for the center of their respective cluster and maintains minimal similarity to elements of other clusters. Element B2 wherein the at least one processor is further configured to select the subset of elements which satisfies the proximity criterion for the center of their respective cluster and applies geologic criteria. Element B3 wherein the reservoir comprises a hydrocarbon reservoir.

Embodiment C: A non-transitory computer-readable storage medium, the computer-readable storage medium including instructions that when executed by at least one processor, cause the at least one processor to: compute a symmetric correlation matrix (SCM) having a number of elements, wherein each element of the SCM represents a correlation coefficient of a respective pair of component concentrations across all samples in a set of samples collected from different locations of a compartmentalized reservoir; apply a first clustering algorithm on the elements of the SCM to obtain a set of distinct clusters and selecting a subset of elements within each cluster which satisfy a proximity criterion for a center of their respective cluster; apply a second clustering algorithm to the set of samples based on a selected group of component concentrations to obtain a grouping of the samples wherein the number of clusters is selected based on a point of linear discontinuity in a Euclidean distance trend function; and assign each sample from the set of samples to a respective compartment of the reservoir to obtain a compartment distribution of the set of samples across multiple compartments of the reservoir.

Embodiment C may have one or more of the following additional elements C1-C2 in any combination or all in combination. Element C1 wherein the computer-readable storage medium further includes instructions that when executed by the at least one processor, cause the at least one processor to select the subset of elements which satisfies the proximity criterion for the center of their respective cluster and maintains minimal similarity to elements of other clusters. Element C2 wherein the computer-readable storage medium further includes instructions that when executed by the at least one processor, cause the at least one processor to select the subset of elements which satisfies the proximity criterion for the center of their respective cluster and applies geologic criteria.

Embodiment D: A system for determining a distribution of a set of samples among multiple compartments of a reservoir comprising: a data repository configured to store data representative of a set of samples collected from different locations of a compartmentalized reservoir; an analysis tool including a geochemical data analyzer and a reservoir mapper; and a user-interface configured to enable a user to interact with the analysis tool and the data repository; wherein the geochemical data analyzer is configured to: compute a symmetric correlation matrix (SCM) having a number of elements, wherein each element of the SCM represents a correlation coefficient of a respective pair of component concentrations across all samples in a set of samples collected from different locations of a compartmentalized reservoir; apply a first clustering algorithm on the elements of the SCM to obtain a set of distinct clusters and selecting a subset of elements within each cluster which satisfy a proximity criterion for a center of their respective cluster; and apply a second clustering algorithm to the set of samples based on a selected group of component concentrations to obtain a grouping of the samples wherein the number of clusters is selected based on a point of linear discontinuity in a Euclidean distance trend function; and wherein the reservoir mapper is configured to assign each sample from the set of samples to a respective compartment of the reservoir to obtain a compartment distribution of the set of samples across multiple compartments of the reservoir.

Embodiment D may have one or more of the following additional elements D1-D4 in any combination or all in combination. Element D1 wherein the data repository stores sample location data and concentration composition data for the set of samples collected from different locations of the compartmentalized reservoir. Element D2 wherein the geochemical data analyzer outputs the computed SCM for storage in the data repository. Element D3 wherein the data repository further stores correlation threshold indices and a Euclidean distance trend function for access by the geochemical data analyzer. Element D4 wherein the reservoir mapper further outputs the compartment distribution for storage in the data repository, and wherein the analysis tool generates a display view of the compartment distribution and the user-interface enables a user to view and navigate through compartment distribution shown in the display view.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

What is claimed is:

1. A computer-implemented method for determining a distribution of a set of samples among multiple compartments of a reservoir, comprising:
storing, in computer-readable memory, a concentration composition of multiple components in a set of samples collected from different locations of the compartmentalized reservoir;
computing, with at least one processor, a symmetric correlation matrix (SCM) having a number of elements, wherein each element of the SCM represents a correlation coefficient of a respective pair of component concentrations across all samples in the collected set;
applying, with at least one processor, a first clustering algorithm on the elements of the SCM to obtain a set of distinct clusters and selecting a subset of elements within each cluster which satisfy a proximity criterion for a center of their respective cluster;
applying, with at least one processor, a second clustering algorithm to the set of samples based on a selected group of component concentrations to obtain a grouping of the samples wherein the number of clusters is selected based on a point of linear discontinuity in a Euclidean distance trend function; and
assigning, with at least one processor, each sample from the set of samples to a respective compartment of the reservoir to obtain a compartment distribution of the set of samples across multiple compartments of the reservoir.

2. The computer-implemented method of claim 1, further comprising executing a field operation based on the assigned compartment distribution.

3. The computer-implemented method of claim 1, wherein the selecting the subset of elements which satisfies the proximity criterion for the center of their respective cluster includes maintaining minimal similarity to elements of other clusters.

4. The computer-implemented method of claim 1, wherein the selecting the subset of elements which satisfies the proximity criterion for the center of their respective cluster includes applying geologic criteria.

5. The computer-implemented method of claim 1, wherein the reservoir comprises a hydrocarbon reservoir.

6. A computing apparatus for determining a distribution of a set of samples among multiple compartments of a reservoir comprising:
computer-readable memory configured to store a concentration composition of multiple components in a set of samples collected from different locations of the compartmentalized reservoir; and
at least one processor configured to perform the following operations:
compute a symmetric correlation matrix (SCM) having a number of elements, wherein each element of the SCM represents a correlation coefficient of a respective pair of component concentrations across all samples in the collected set;
apply a first clustering algorithm on the elements of the SCM to obtain a set of distinct clusters and selecting a subset of elements within each cluster which satisfy a proximity criterion for a center of their respective cluster;
apply a second clustering algorithm to the set of samples based on a selected group of component concentrations to obtain a grouping of the samples wherein the number of clusters is selected based on a point of linear discontinuity in a Euclidean distance trend function; and
assign each sample from the set of samples to a respective compartment of the reservoir to obtain a compartment distribution of the set of samples across multiple compartments of the reservoir.

7. The computing apparatus of claim 6, wherein the at least one processor is further configured to select the subset of elements which satisfies the proximity criterion for the center of their respective cluster and maintains minimal similarity to elements of other clusters.

8. The computing apparatus of claim 6, wherein the at least one processor is further configured to select the subset of elements which satisfies the proximity criterion for the center of their respective cluster and applies geologic criteria.

9. The computing apparatus of claim 6, wherein the reservoir comprises a hydrocarbon reservoir.

10. A non-transitory computer-readable storage medium, the computer-readable storage medium including instructions that when executed by at least one processor, cause the at least one processor to:
compute a symmetric correlation matrix (SCM) having a number of elements, wherein each element of the SCM represents a correlation coefficient of a respective pair of component concentrations across all samples in a set of samples collected from different locations of a compartmentalized reservoir;
apply a first clustering algorithm on the elements of the SCM to obtain a set of distinct clusters and selecting a subset of elements within each cluster which satisfy a proximity criterion for a center of their respective cluster;
apply a second clustering algorithm to the set of samples based on a selected group of component concentrations to obtain a grouping of the samples wherein the number of clusters is selected based on a point of linear discontinuity in a Euclidean distance trend function; and
assign each sample from the set of samples to a respective compartment of the reservoir to obtain a compartment distribution of the set of samples across multiple compartments of the reservoir.

11. The non-transitory computer-readable storage medium of claim 10, wherein the computer-readable storage medium further includes instructions that when executed by the at least one processor, cause the at least one processor to select the subset of elements which satisfies the proximity criterion for the center of their respective cluster and maintains minimal similarity to elements of other clusters.

12. The non-transitory computer-readable storage medium of claim 10, wherein the computer-readable storage medium further includes instructions that when executed by the at least one processor, cause the at least one processor to select the subset of elements which satisfies the proximity criterion for the center of their respective cluster and applies geologic criteria.

13. A system for determining a distribution of a set of samples among multiple compartments of a reservoir comprising:
a data repository configured to store data representative of a set of samples collected from different locations of a compartmentalized reservoir;
an analysis tool including a geochemical data analyzer and a reservoir mapper;
and a user-interface configured to enable a user to interact with the analysis tool and the data repository;
wherein the geochemical data analyzer is configured to:
compute a symmetric correlation matrix (SCM) having a number of elements, wherein each element of the SCM represents a correlation coefficient of a respective pair of component concentrations across all samples in a set of samples collected from different locations of a compartmentalized reservoir;
apply a first clustering algorithm on the elements of the SCM to obtain a set of distinct clusters and selecting a subset of elements within each cluster which satisfy a proximity criterion for a center of their respective cluster; and
apply a second clustering algorithm to the set of samples based on a selected group of component concentrations to obtain a grouping of the samples wherein the number of clusters is selected based on a point of linear discontinuity in a Euclidean distance trend function; and
wherein the reservoir mapper is configured to assign each sample from the set of samples to a respective compartment of the reservoir to obtain a compartment distribution of the set of samples across multiple compartments of the reservoir.

14. The system of claim 13, wherein the data repository stores sample location data and concentration composition data for the set of samples collected from different locations of the compartmentalized reservoir.

15. The system of claim 14, wherein the geochemical data analyzer outputs the computed SCM for storage in the data repository.

16. The system of claim 15, wherein the data repository further stores correlation threshold indices and a Euclidean distance trend function for access by the geochemical data analyzer.

17. The system of claim 16, wherein the reservoir mapper further outputs the compartment distribution for storage in the data repository, and wherein the analysis tool generates a display view of the compartment distribution and the user-interface enables a user to view and navigate through compartment distribution shown in the display view.
